(19) United States
(12) Patent Application Publication
(10) Pub. No.: US 2018/0351417 A1
(43) Pub. Date: Dec. 6, 2018

(54) ROTATING ELECTRIC MACHINE STATOR, ROTATING ELECTRIC MACHINE, AND METHOD FOR MANUFACTURING ROTATING ELECTRIC MACHINE STATOR

(71) Applicant: Mitsubishi Electric Corporation, Chiyoda-ku, Tokyo (JP)

(72) Inventor: Hironori TSUIKI, Tokyo (JP)

(73) Assignee: Mitsubishi Electric Corporation, Chiyoda-ku, Tokyo (JP)

(21) Appl. No.: 15/770,312

(22) PCT Filed: Jan. 6, 2017
(86) PCT No.: PCT/JP2017/000211

§ 371 Date: Apr. 23, 2018

(30) Foreign Application Priority Data
Feb. 18, 2016 (JP) 2016-028751

(51) Int. Cl. H02K 1/14; H02K 3/18; H02K 3/32; H02K 15/095; H02K 15/02

(52) U.S. Cl. CPC H02K 1/148; H02K 3/18; H02K 2203/12; H02K 15/095; H02K 15/022; H02K 3/325

(57) ABSTRACT

A core is formed of an outer core forming a yoke portion and an inner core forming tooth portions and connection portions. The outer core is divided in a circumferential direction. A first fitting portion for fitting the outer core and the inner core to each other is formed in the outer core and the inner core. Fitting surfaces in a radial direction of the first fitting portion are formed as surfaces parallel to the radial direction at a center position in the circumferential direction of the divided outer core.

### TECHNICAL FIELD

The present invention relates to a stator for a rotating electric machine, a rotating electric machine, and a method for manufacturing a stator for a rotating electric machine that prevent damage of coils and have excellent productivity.

### BACKGROUND ART

In recent years, rotating electric machines such as electric motors and power generators have been required to cause less vibration and have high output. One method for achieving a motor that causes less vibration and has high output is a method in which the width of the slot opening of a stator is narrowed. If the slot opening width is narrowed, the saliency of the stator is decreased to inhibit vibration, and the surface on which a magnetic flux is generated increases, so that the gap between the stator and the rotor can be equivalently reduced to increase output. However, since it is necessary to insert a winding into the slot, the slot opening width needs to be equal to or larger than at least twice the wire diameter of a coil.

For these problems, for example, Patent Document 1 proposes a rotating electric machine configured by: using inner and outer divided cores obtained by connecting collar portions at tooth ends of a core and dividing tooth portions and a back yoke portion; and inserting a coil from the radially outer side.

Moreover, for example, Patent Document 2 proposes a method in which each tooth is divided and mounted to an opening portion later.

### CITATION LIST

### Patent Document

Patent Document 1: Japanese Laid-Open Patent Publication No. 6-178468
Patent Document 2: Japanese Laid-Open Patent Publication No. 2000-50540

### SUMMARY OF THE INVENTION

### Problems to be Solved by the Invention

For the conventional core disclosed in Patent Document 1, it is necessary to insert the yoke portion for magnetically connecting the teeth, from the axial direction after insertion of the coil. For this, it is necessary to bend coil ends and bobbins radially inward as necessary, and thus the flexibility in design is reduced. In addition, if a step of inserting a rotor is present as a subsequent step, it is necessary to add a step of bending outward the coil ends that have been bent radially inward. Thus, there is a problem in that the productivity deteriorates.

In the method disclosed in Patent Document 2, the productivity is improved. However, since each tooth portion is mounted after a winding is provided, there is a problem in that a yoke portion may deform to damage a coil when each tooth is inserted.

The present invention has been made to solve the above-described problems, and an object of the present invention is to provide a stator for a rotating electric machine, a rotating electric machine, and a method for manufacturing a stator for a rotating electric machine that prevent damage of coils and have excellent productivity.

### Solution to the Problems

A stator for a rotating electric machine according to the present invention includes:

a core having
a yoke portion formed in an annular shape,
a plurality of tooth portions formed at an inner peripheral side of the yoke portion so as to be spaced apart from each other at intervals in a circumferential direction and project to an inner side in a radial direction with respect to the yoke portion, and
connection portions connecting the adjacent tooth portions at the inner side in the radial direction; and

coils disposed in slots between the respective tooth portions, wherein

the core is formed of an outer core forming the yoke portion and an inner core forming the tooth portions and the connection portions,

the outer core is formed so as to be divided into a plurality of parts in the circumferential direction,

a first fitting portion for fitting the outer core and the inner core to each other is formed in the outer core and the inner core, and

a fitting surface in the radial direction of the first fitting portion is formed as a surface parallel to the radial direction at a center position in the circumferential direction of the divided outer core.

A rotating electric machine according to the present invention is a rotating electric machine including:

the stator described above; and

a rotor disposed so as to be concentric with the stator.

A method for manufacturing a stator for a rotating electric machine according to the present invention is a method for manufacturing the above stator for a rotating electric machine, the method including:

a first step of disposing the coils in the respective slots of the inner core; and

a second step of inserting the divided outer cores from an outer side in the radial direction of the inner core and fitting the inner core and the outer core at the first fitting portion.

### Effect of the Invention

The stator for a rotating electric machine, the rotating electric machine, and the method for manufacturing the stator for a rotating electric machine according to the present invention prevent damage of the coils and have excellent productivity.

### BRIEF DESCRIPTION OF THE DRAWINGS

FIG. 1 is a diagram showing the configuration of a rotating electric machine according to Embodiment 1 of the present invention.

FIG. 2 is a perspective view showing the configuration of a stator of the rotating electric machine shown in FIG. 1.

FIG. 3 is a perspective view showing the configuration of a core of the stator shown in FIG. 2.

FIG. 4 is a perspective view showing the configuration of an inner core of the core shown in FIG. 3.

FIG. 5 is a plan view showing the configuration of the inner core shown in FIG. 4.

FIG. 6 is a perspective view showing the configuration of an outer core of the core shown in FIG. 3.

FIG. 7 is a plan view showing the configuration of the outer core shown in FIG. 6.

FIG. 8 is a plan view showing a method for manufacturing the stator of the rotating electric machine shown in FIG. 2.

FIG. 9 is a plan view showing the method for manufacturing the stator of the rotating electric machine shown in FIG. 2.

FIG. 10 is a plan view showing the method for manufacturing the stator of the rotating electric machine shown in FIG. 2.

FIG. 11 is a plan view showing the method for manufacturing the stator of the rotating electric machine shown in FIG. 2.

FIG. 12 is a longitudinal cross-sectional view showing the method for manufacturing the stator of the rotating electric machine shown in FIG. 2.

FIG. 13 is a perspective view showing the configuration of a stator for a rotating electric machine according to Embodiment 2 of the present invention.

FIG. 14 is a perspective view showing the configuration of a core of the stator shown in FIG. 13

FIG. 15 is a perspective view showing the configuration of an inner core of the core shown in FIG. 14.

FIG. 16 is a plan view showing the configuration of the inner core shown in FIG. 15.

FIG. 17 is a perspective view showing the configuration of an outer core of the core shown in FIG. 14.

FIG. 18 is a plan view showing the configuration of the outer core shown in FIG. 17.

FIG. 19 is a plan view showing a method for manufacturing the stator for a rotating electric machine shown in FIG. 13.

FIG. 20 is a plan view showing the method for manufacturing the stator for a rotating electric machine shown in FIG. 13.

FIG. 21 is a plan view showing the method for manufacturing the stator for a rotating electric machine shown in FIG. 13.

FIG. 22 is a plan view showing the method for manufacturing the stator for a rotating electric machine shown in FIG. 13.

FIG. 23 is a plan view showing the configuration of a stator for a rotating electric machine according to Embodiment 3 of the present invention.

FIG. 24 is a plan view showing a method for manufacturing the stator for a rotating electric machine shown in FIG. 23.

FIG. 25 is a plan view showing the method for manufacturing the stator for a rotating electric machine shown in FIG. 23.

FIG. 26 is a longitudinal cross-sectional view showing a method for manufacturing a stator for a rotating electric machine according to a reference example.

### DESCRIPTION OF EMBODIMENTS

### Embodiment 1

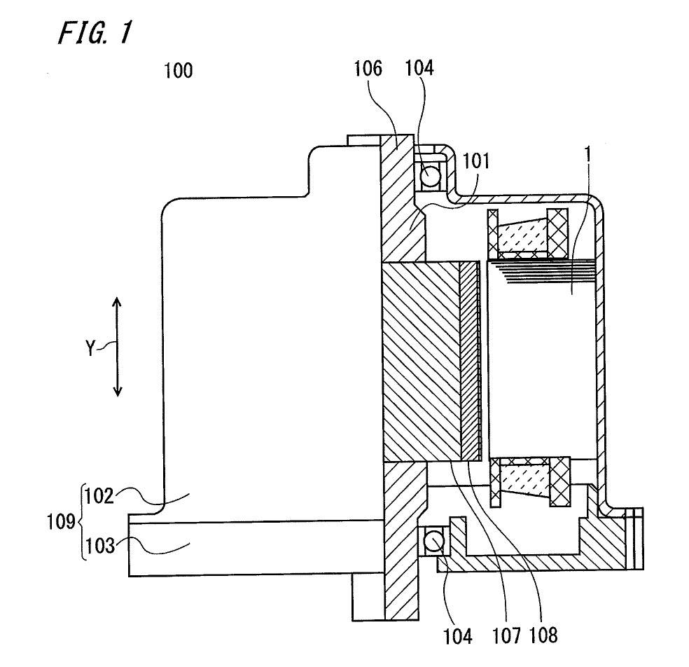

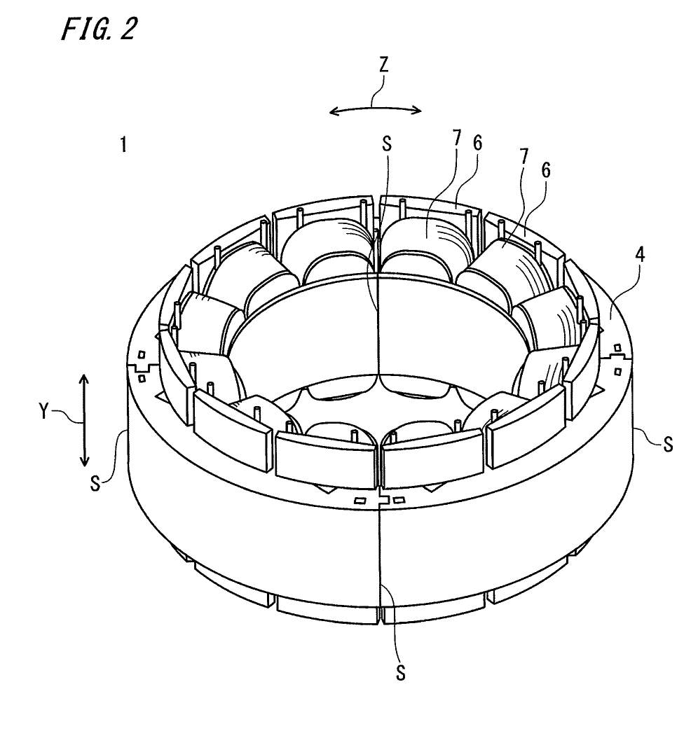

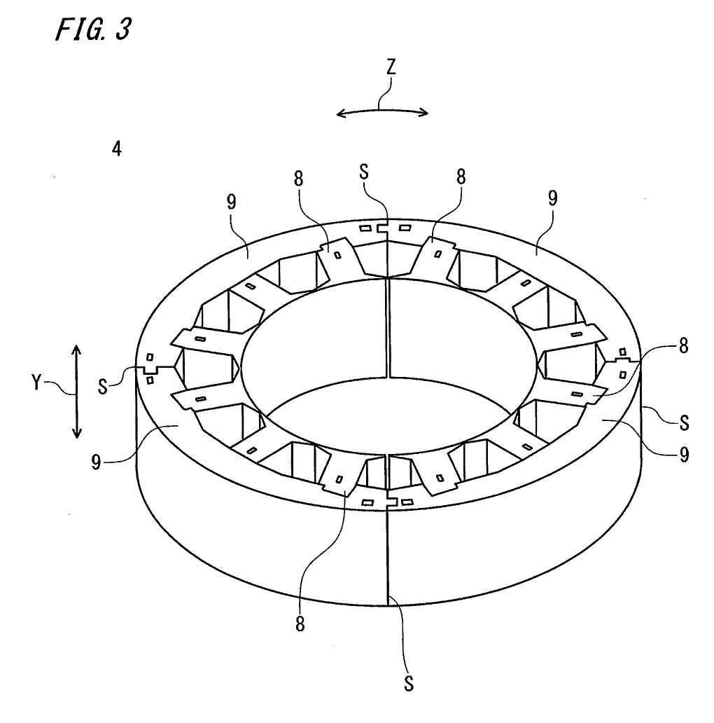

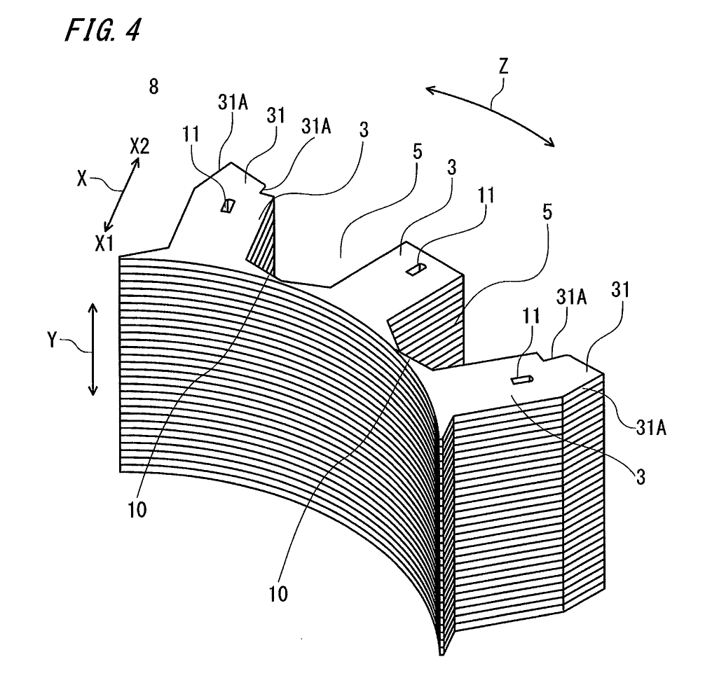

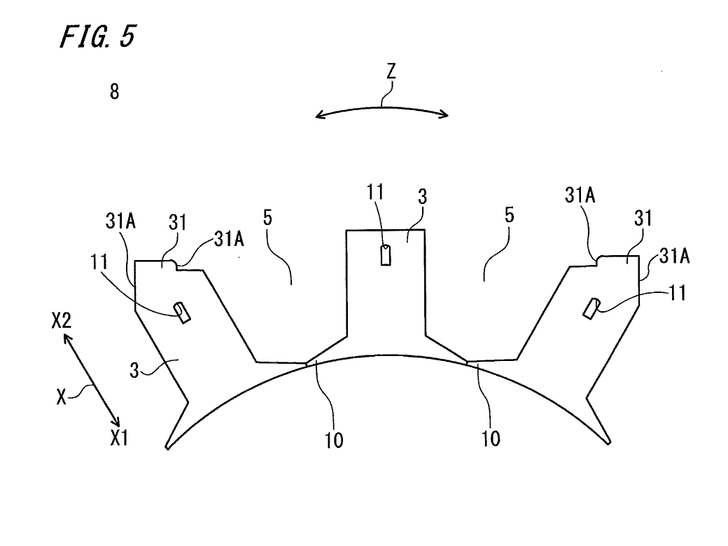

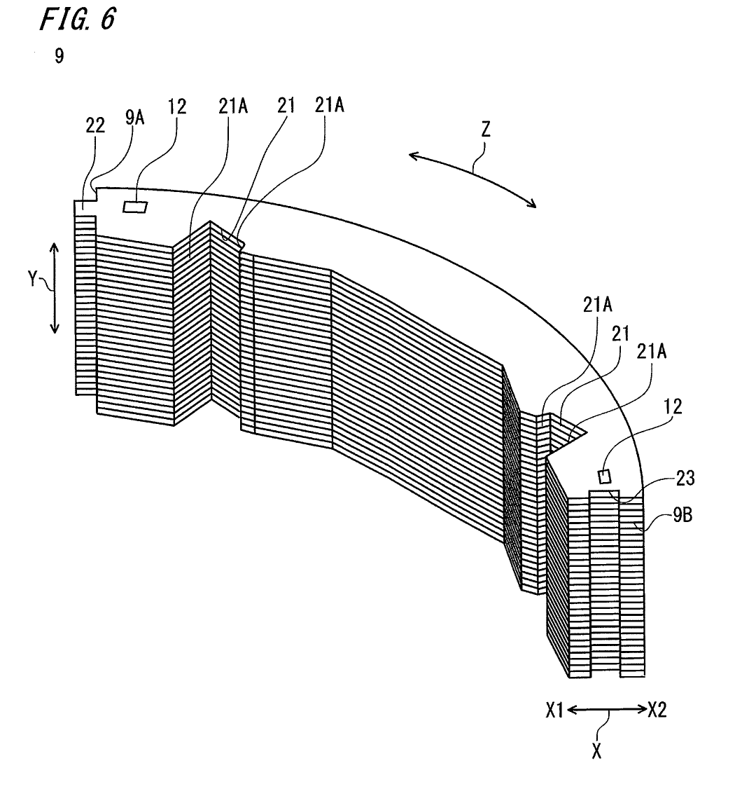

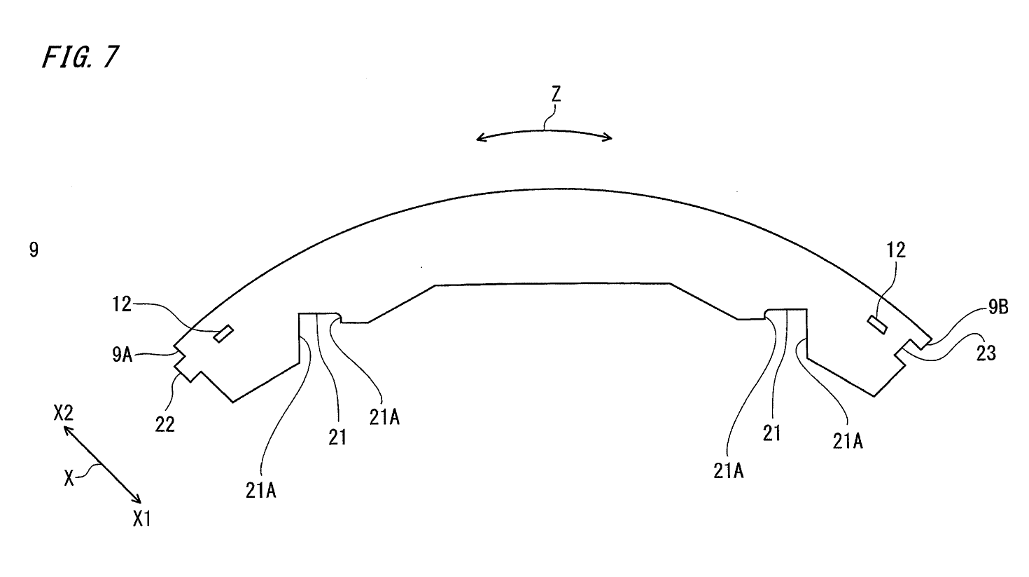

Hereinafter, embodiments of the present invention will be described. FIG. 1 is a single-side longitudinal sectional side view showing the configuration of a rotating electric machine according to Embodiment 1 of the present invention. FIG. 2 is a perspective view showing the configuration of a stator of the rotating electric machine shown in FIG. 1. FIG. 3 is a perspective view showing the configuration of a core of the stator shown in FIG. 2. FIG. 4 is a perspective view showing the configuration of an inner core of the core shown in FIG. 3. FIG. 5 is a plan view showing the configuration of the inner core shown in FIG. 4. FIG. 6 is a perspective view showing the configuration of an outer core of the core shown in FIG. 3. FIG. 7 is a plan view showing the configuration of the outer core shown in FIG. 6.

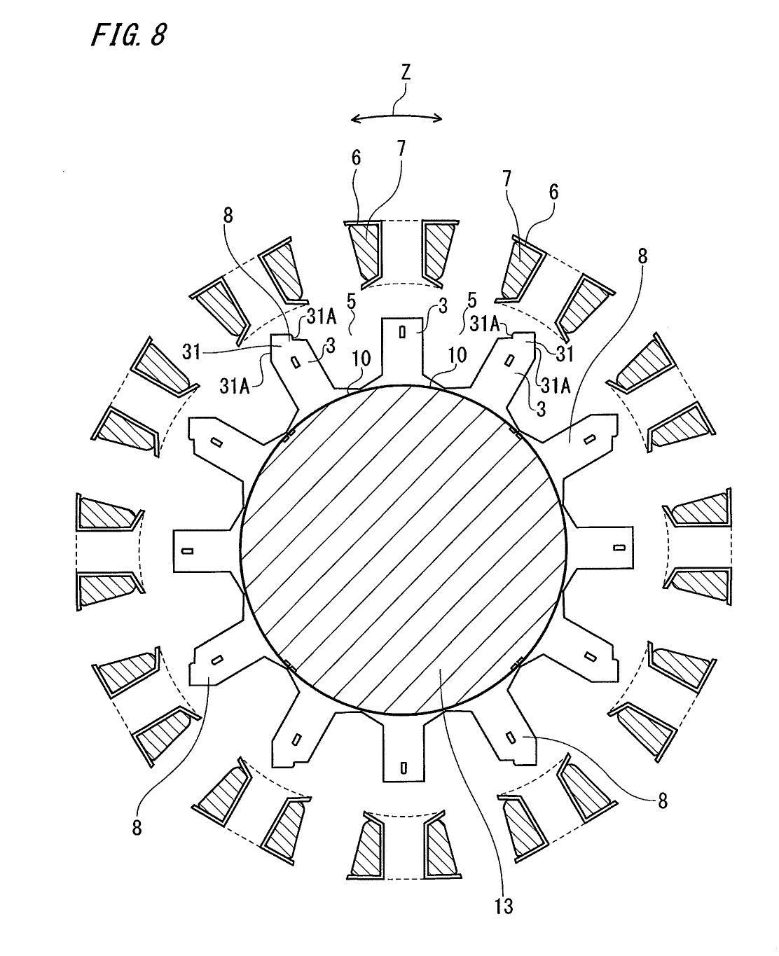

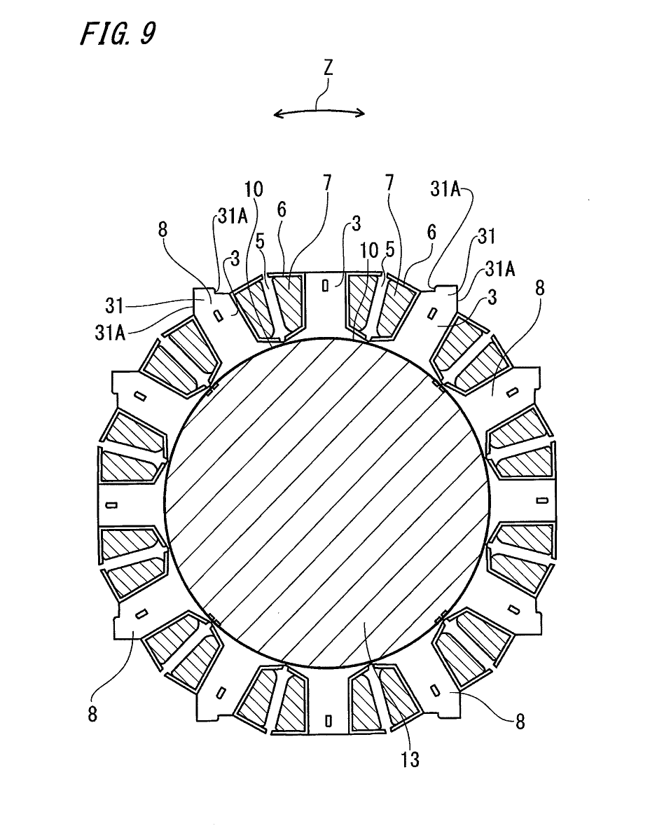

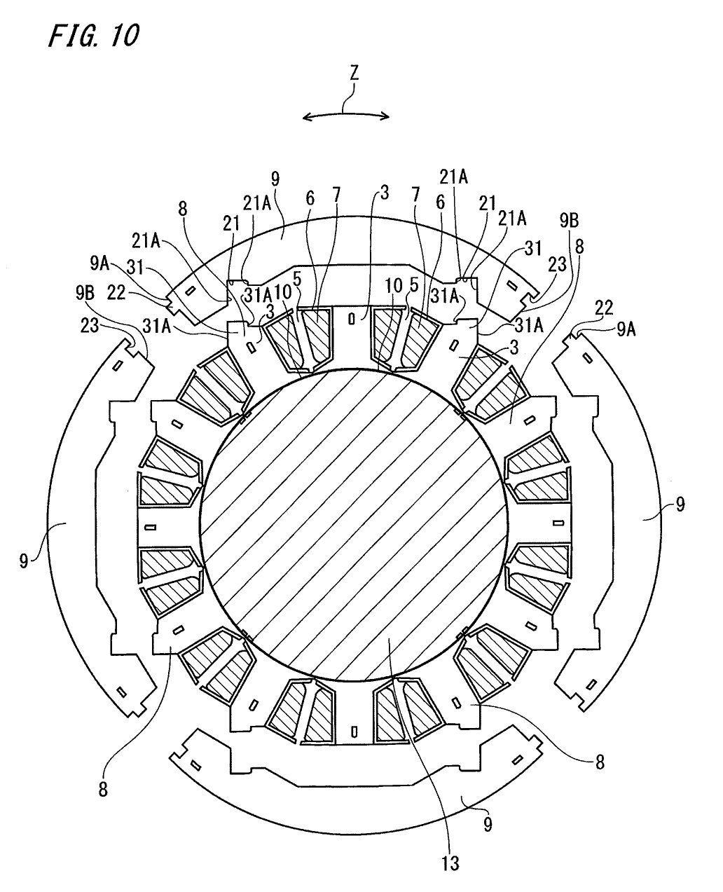

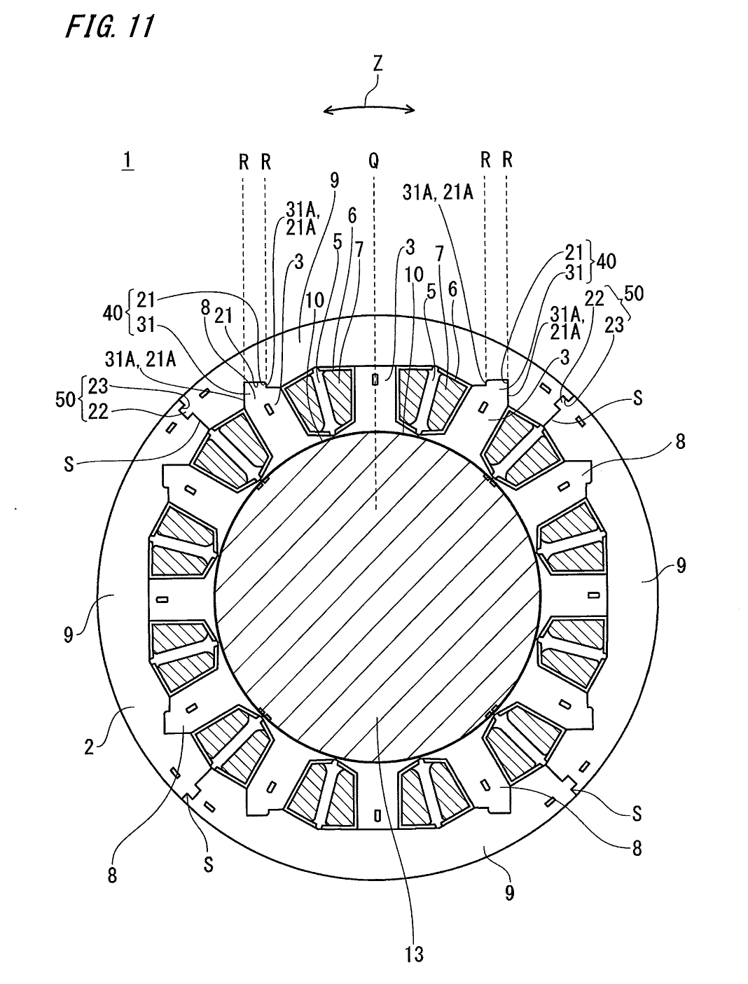

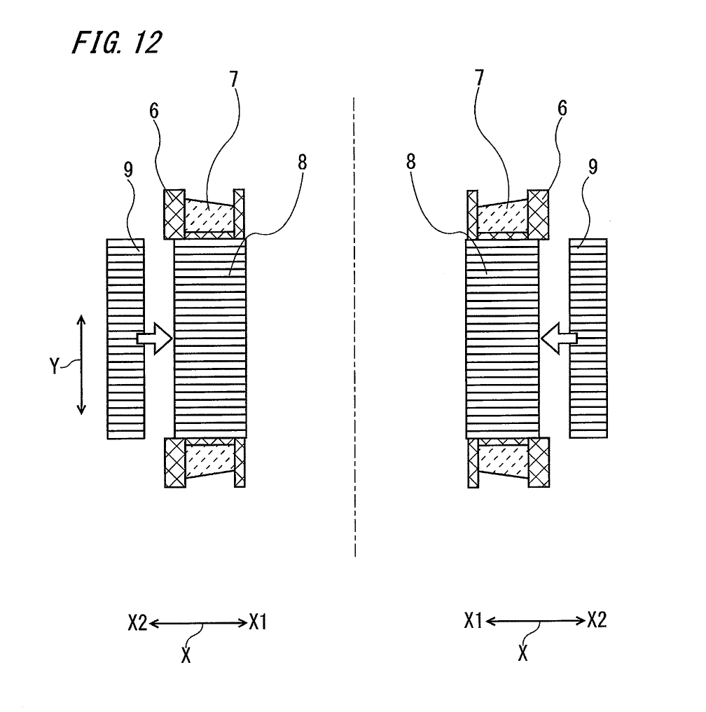

FIGS. 8 to 11 are each a plan view showing a method for manufacturing the stator of the rotating electric machine shown in FIG. 2. FIG. 12 is a longitudinal cross-sectional view showing the method for manufacturing the stator of the rotating electric machine shown in FIG. 2. FIG. 8 is a plan view showing a state before coils are mounted to the inner core. FIG. 9 is a plan view showing a state after the coils are mounted to the inner core. FIG. 10 is a plan view showing a state before the outer core is mounted to the inner core. FIG. 11 is a plan view showing a state after the outer core is mounted to the inner core. FIG. 12 is a longitudinal cross-sectional view schematically showing a cross-section in the axial direction in the state, before the outer core is mounted to the inner core, corresponding to FIG. 10.

In FIG. 1, a rotating electric machine 100 includes a stator 1 and a rotor 101 disposed within an annular shape of the stator 1. The rotating electric machine 100 is housed in a housing 109 that includes: a frame 102 having a cylindrical shape with a bottom; and an end plate 103 closing the opening of the frame 102. The stator 1 is fixed within the cylindrical portion of the frame 102 in a fitted state. The rotor 101 is fixed to a rotation shaft 106 that is rotatably supported by the bottom portion of the frame 102 and the end plate 103 via a bearing 104.

The rotor 101 is formed by: a rotor core 107 that is fixed to the rotation shaft 106 inserted at an axial position; and permanent magnets 108 that are embedded at the outer peripheral surface side of the rotor core 107 and arranged at predetermined intervals in a circumferential direction Z and that form magnetic poles. The rotor 101 is shown as a permanent-magnet-type rotor here, but is not limited thereto, and a squirrel-cage rotor in which conductor wires not provided with an insulating coating are accommodated in slots and short-circuited at both sides by short-circuit rings, or a wound rotor in which conductor wires provided with an insulating coating are mounted to slots of a rotor core, may be used.

In FIG. 2, the stator 1 includes a core 4, coils 7, and bobbins 6. The bobbins 6 are winding frames for the coils 7 and electrically insulate the coils 7 and the core 4. The stator 1 is formed by mounting the bobbins 6 having the coils 7 wound thereon, to the core 4.

In FIG. 3, the core 4 includes an inner core 8 and an outer core 9. The outer core 9 forms a yoke portion 2 in an annular shape. The outer core 9 is formed so as to be divided into a plurality of parts in the circumferential direction Z. In the inner core 8, tooth portions 3 and connection portions 10 are formed. A plurality of tooth portions 3 are formed at the inner peripheral side of the yoke portion 2 so as to be spaced apart from each other at intervals in the circumferential direction Z and project to an inner side X1 in a radial direction X with respect to the yoke portion 2 in order to form magnetic poles. The connection portions 10 connect the tooth portions 3 adjacent to each other in the circumferential direction Z, at the inner side X1 in the radial direction X. In addition, first fitting portions 40 for fitting the inner core 8 and the outer core 9 to each other are formed in the inner core 8 and the outer core 9.

In Embodiment 1, an example in which the inner core 8 is formed so as to be divided into four parts is shown. FIGS. 4 and 5 show one divided inner core 8. As shown in the drawings, in Embodiment 1, an example in which not all the tooth portions 3 are connected by the connection portions 10 and three tooth portions 3 are connected by the connection portions 10 in one inner core 8, is shown.

The inner core 8 is formed of magnetic steel sheets stacked in an axial direction Y, and the magnetic steel sheets are connected to each other in the axial direction Y by swage portions 11 formed in the inner core 8. The connection portions 10 are collar portions formed at the inner side X1 in the radial direction X of the tooth portions 3, and are formed as thin portions at locations in the axial direction Y so as to partially connect the tooth portions 3.

A plurality of slots 5 demarcated in the circumferential direction Z are formed between the tooth portions 3 adjacent to each other in the circumferential direction Z. First projections 31 are formed as the first fitting portions 40 at an outer side X2 in the radial direction X with respect to the slots 5 and on the tooth portions 3 at both sides in the circumferential direction Z of one inner core 8. A fitting surface 31A is formed on each first projection 31 in the radial direction X.

Next, the outer core 9 will be described. In Embodiment 1, an example in which the outer core 9 is formed so as to be divided into four parts is shown. FIGS. 6 and 7 show one divided outer core 9. Similar to the inner core 8, the outer core 9 is formed of magnetic steel sheets stacked in the axial direction Y. The magnetic steel sheets are connected to each other in the axial direction Y by swage portions 12 formed in the outer core 9. Division locations S of the outer core 9 are locations at which the slots 5 are formed, in the circumferential direction Z, as shown in FIGS. 3 and 11.

The four outer cores 9 form the annular yoke portion 2 and magnetically connect the respective tooth portions 3. First recesses 21 are formed as the first fitting portions 40 at the outer side X2 in the radial direction X with respect to the slots 5 in one outer core 9. As a matter of course, the first recesses 21 are formed at locations corresponding to the aforementioned first projections 31 of the inner core 8. Fitting surfaces 21A are formed on the first recesses 21 in the radial direction X.

The first recesses 21 are fitted to the aforementioned first projections 31 of the inner core 8. The first fitting portions 40 are formed by the first recesses 21 and the first projections 31. In this case, the fitting surfaces 31A of the first projections 31 and the fitting surfaces 21A of the first recesses 21 are in contact with each other. Second fitting portions 50 for fitting end portions 9A and 9B in the circumferential direction Z of the divided outer cores 9 are formed at the end portions 9A and 9B in the circumferential direction Z of one outer core 9.

Second projections 22 are formed as the second fitting portions 50 on the end portions 9A that are ends of the outer cores 9. Second recesses 23 are formed as the second fitting portions 50 on the end portions 9B that are the other ends of the outer cores 9. The second projection 22 of one outer core 9 and the second recess 23 of another outer core 9 adjacent thereto are fitted to each other, so that the second fitting portion 50 is formed by the second projection 22 and the second recess 23.

The directions in which the fitting surfaces 31A are formed in the inner cores 8 and the fitting surfaces 21A are formed in the outer cores 9 will be described with reference to FIG. 11. Each fitting surface 31A and each fitting surface 21A are formed as surfaces in the axial direction Y at a parallel position R parallel to the radial direction X at a center position Q in the circumferential direction Z of the divided outer core 9. The radial direction X at the center position Q in the circumferential direction Z of the divided outer core 9 is a direction that coincides with an insertion direction in which the divided outer core 9 is inserted from the outer side X2 to the inner side X1 in the radial direction X.

Next, the method for manufacturing the stator of the rotating electric machine of Embodiment 1 configured as described above will be described with reference to FIGS. 8 to 12. First, as shown in FIG. 8, the connection portions 10 at the inner side X1 in the radial direction X of the four inner cores 8 are brought into contact with the outer periphery of a columnar core metal 13 and arranged in an annular shape. Accordingly, in this state, the respective tooth portions 3 are radially formed, and the slots 5 between the adjacent tooth portions 3 are opened at the outer side X2 in the radial direction X.

Next, the coils 7 wound on the bobbins 6 are inserted to the radially arranged tooth portions 3 from the outer side X2 to the inner side X1 in the radial direction X. Accordingly, each bobbin 6 is disposed in the adjacent slots 5 as shown in FIG. 9. Thus, the coils 7 are disposed in the respective slots 5. At this time, the first projections 31 project to the outer side X2 in the radial direction X with respect to the regions of the slots 5 where the coils 7 are disposed.

Next, after the coils 7 are inserted, the four outer cores 9 are inserted from the outer side X2 to the inner side X1 in the radial direction X as shown in FIGS. 10, 11, and 12. Then, the first projections 31 of the inner cores 8 and the first recesses 21 of the outer cores 9 are fitted to each other to form the first fitting portions 40. The insertion direction in which each outer core 9 is inserted at this time coincides with the radial direction X at the center position Q in the circumferential direction Z of the divided outer core 9. Since each of the fitting surfaces 31A of the first projections 31 of each inner core 8 and each of the fitting surfaces 21A of the first recesses 21 of each outer core 9 are formed as surfaces in the axial direction Y at the parallel position R with respect to the radial direction X at the center position Q in the circumferential direction Z of the outer core 9, that is, the insertion direction, it is easy to insert the outer cores 9 to the inner cores 8.

Furthermore, the first fitting portions 40 composed of the first projections 31 and the first recesses 21 are formed at the outer side X2 in the radial direction X with respect to the slots 5. Thus, when the first projections 31 and the first recesses 21 are fitted to each other, stress can be prevented from being applied to the coils 7 disposed within the slots 5.

Furthermore, at the end portions 9A and 9B in the circumferential direction Z of the respective outer cores 9, the second projections 22 and the second recesses 23 are fitted to each other, whereby the second fitting portions 50 are formed. When each outer core 9 is inserted and press-fitted from the outer side X2 to the inner side X1 in the radial direction X, the second projections 22 are press-fitted into the second recesses 23 so as to be squeezed thereinto, whereby the second projections 22 and the second recesses 23 are fitted to each other.

Thereafter, the coils 7 disposed on the respective tooth portions 3 are connected to each other by a predetermined method, so that the stator 1 (armature) of the rotating electric machine 100 is completed. As shown in FIG. 12, since the outer core 9 is formed so as to be divided in the circumferential direction Z, it is possible to assemble the core 4 by movement of the outer core 9 from the outer side X2 to the inner side X1 in the radial direction X.

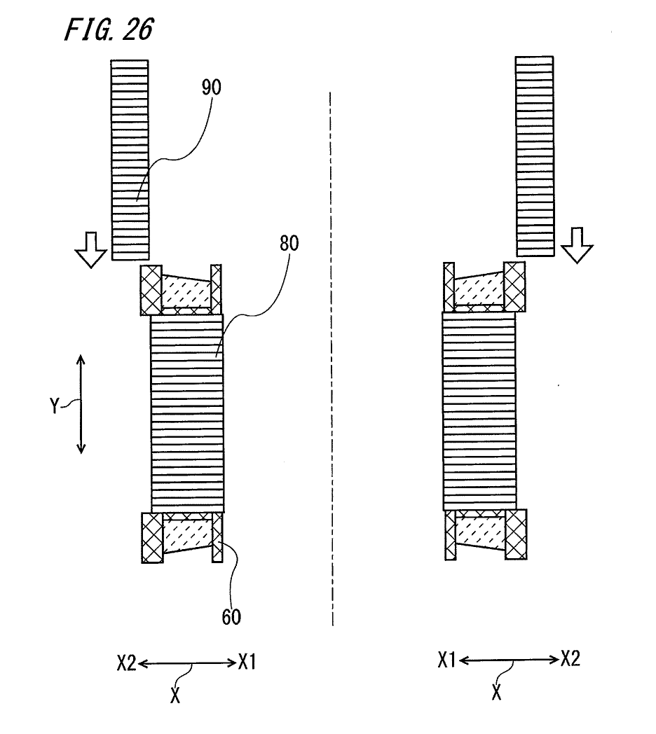

In a reference example of FIG. 26, a case where an annular outer core 90 that is not divided in the circumferential direction Z is inserted to an inner core 80 in the axial direction Y is shown. In this reference example, it is necessary to take into consideration interference between a wall of each bobbin 60 at the outer side X2 in the radial direction X and the outer core 90. However, in Embodiment 1, as shown in FIG. 12, the outer core 9 is moved from the outer side X2 to the inner side X1 in the radial direction X and inserted to the inner core 8. Thus, assembling can be performed without needing to take into consideration interference between a wall of the bobbin 6 at the outer side X2 in the radial direction X and the outer core 9.

According to the stator for a rotating electric machine, the rotating electric machine, and the method for manufacturing the stator for a rotating electric machine of Embodiment 1 configured as described above, since the outer core is divided in the circumferential direction and the fitting surfaces of the first fitting portions are formed parallel to the insertion direction of the outer core, simple assembling is enabled by press-fitting the outer core from the outer side in the radial direction. Furthermore, assembling is enabled without being influenced by the shape of an insulator for each coil, the shapes of the coil ends, and the like.

Insertion force applied when the outer core is inserted to the inner core can be smaller than that of when the outer core is inserted to the inner core in the axial direction, and thus the insertion force can be decreased and the effects such as inhibition of size increase of a facility and improvement of the productivity are achieved. In addition, since the first fitting portions are formed at the outer side in the radial direction of the coils, stress can be prevented from being applied to the coils disposed within the slots, so that damage of the coils is prevented and the productivity is excellent.

Since the first fitting portions are formed by the first recesses of the outer cores and the first projections of the inner cores, the first fitting portions can easily be formed at the outer side in the radial direction with respect to the coils.

Since the outer cores are fitted at the second fitting portions formed at the end portions in the circumferential direction of the outer cores, the outer cores can be assuredly fitted to each other, so that the rigidity thereof can be increased.

Since the division locations of the outer core are locations at which the slots are formed, in the circumferential direction, the outer core can be divided in a simple manner.

Since the coils are formed by being wound on the bobbins disposed in the slots, it is not necessary to take into consideration interference of the outer cores with the bobbins.

In Embodiment 1 described above, the example in which one divided inner core includes three tooth portions is shown. However, the present invention is not limited thereto, and even in the case where each inner core includes a plurality of tooth portions the number of which is different from three, similar formation is possible, and the same advantageous effects can be achieved.

In Embodiment 1 described above, the example in which the outer core is formed so as to be divided into four parts in the circumferential direction is shown. However, the present invention is not limited thereto, and when the outer core is divided into two or more parts the number of which is not greater than the number of tooth portions, the outer core can be formed in a manner similar to the above embodiment.

In Embodiment 1 described above, the example in which one divided inner core includes three tooth portions and no first fitting portion is formed at the tooth portion at the center in the circumferential direction is shown. This is shown as an example in which the inner cores and the outer cores are formed at low cost by setting provision of the first fitting portions at the tooth portions at both sides in the circumferential direction as the minimum requirement for fixing the inner cores and the outer cores.

However, the present invention is not limited thereto; the first fitting portions may be formed at all three tooth portions of one divided inner core, and the corresponding first fitting portions may also be formed at the outer cores. In this case, since the first fitting portions are formed at all the tooth portions unlike Embodiment 1 described above, it is possible to further firmly fix the inner cores and the outer cores.

The stator of Embodiment 1 described above is configured such that the divided inner cores are not in contact with each other at the connection portions for the tooth portions. However, the present invention is not limited thereto, and the divided inner cores may be configured to be in contact with each other at the connection portions for the tooth portions. In this case, a factor that contributes to an increase in cogging torque is reduced.

Embodiment 1 described above shows, as an example, a concentrated winding type configuration in which one coil is wound on one tooth portion in a concentrated manner. However, the present invention is not limited thereto, and even with a distributed winding type configuration in which a coil is disposed over a plurality of tooth portions, the coils can be formed similarly, and the same advantageous effects can be achieved.

In particular, in the case of a distributed winding type, it is not necessary to assemble the outer cores from the axial direction, and thus interference between the outer cores and coil ends protruding outward in the axial direction can be prevented. In the conventional art, in order to avoid this interference, the coil ends are bent radially inward. However, in this case, the rotor cannot be assembled later, and it is necessary to wind the coils in a state where the rotor is assembled. Therefore, there are large constraints on the configuration and the design of a winding machine. According to Embodiment 1, since the outer cores are moved from the outer side to the inner side in the radial direction and assembled, the assembling is enabled without interfering with axially outer protrusion of the coil ends.

These matters are the same as in the following embodiments, and thus the description thereof is omitted as appropriate.

### Embodiment 2

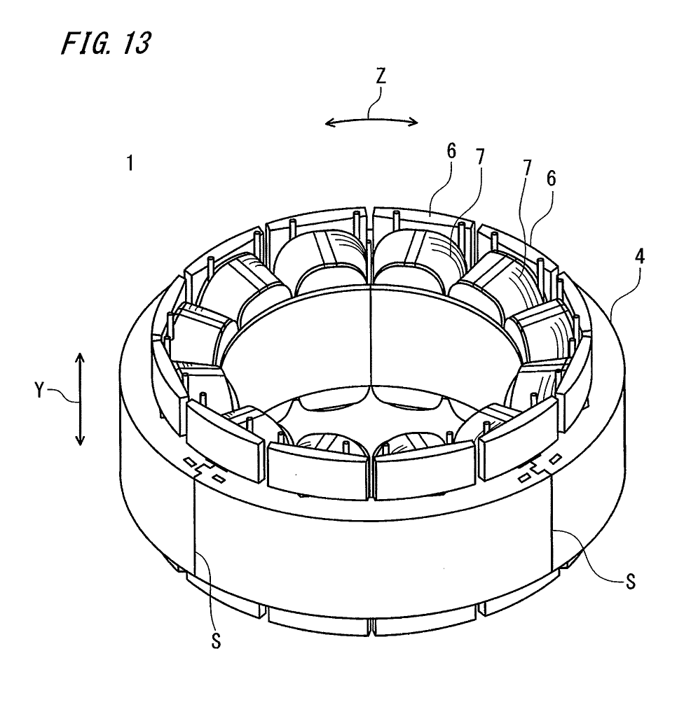

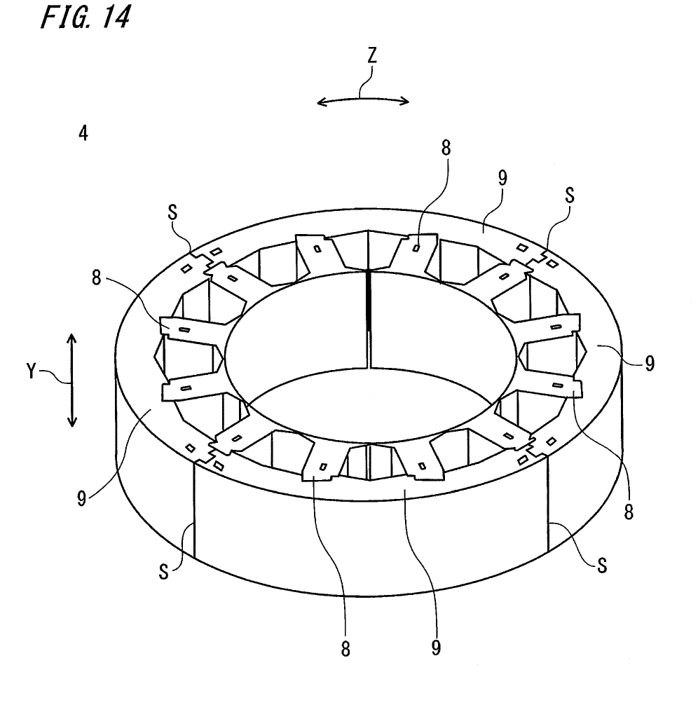

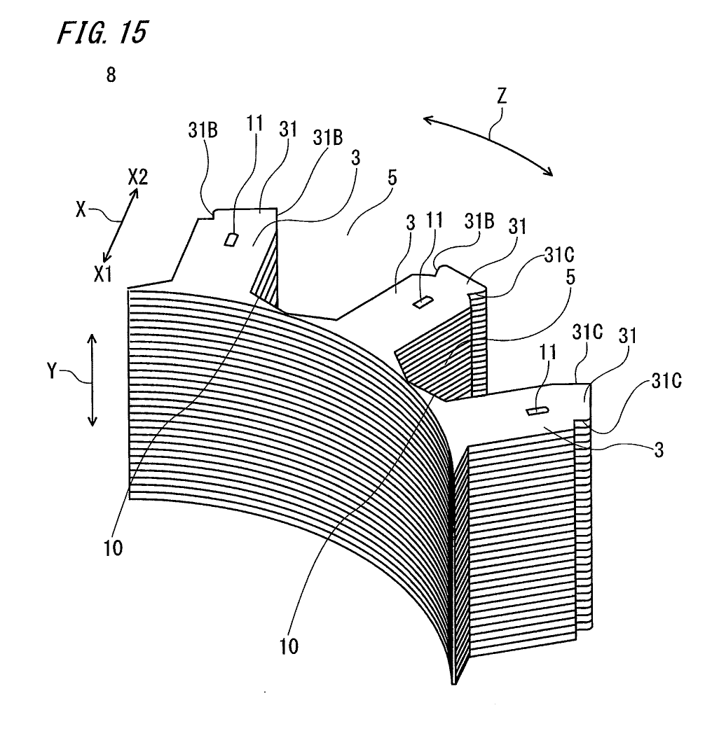

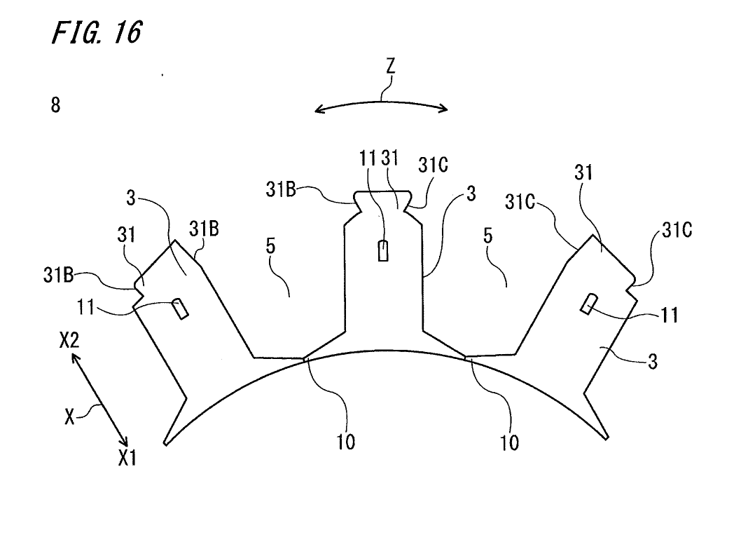

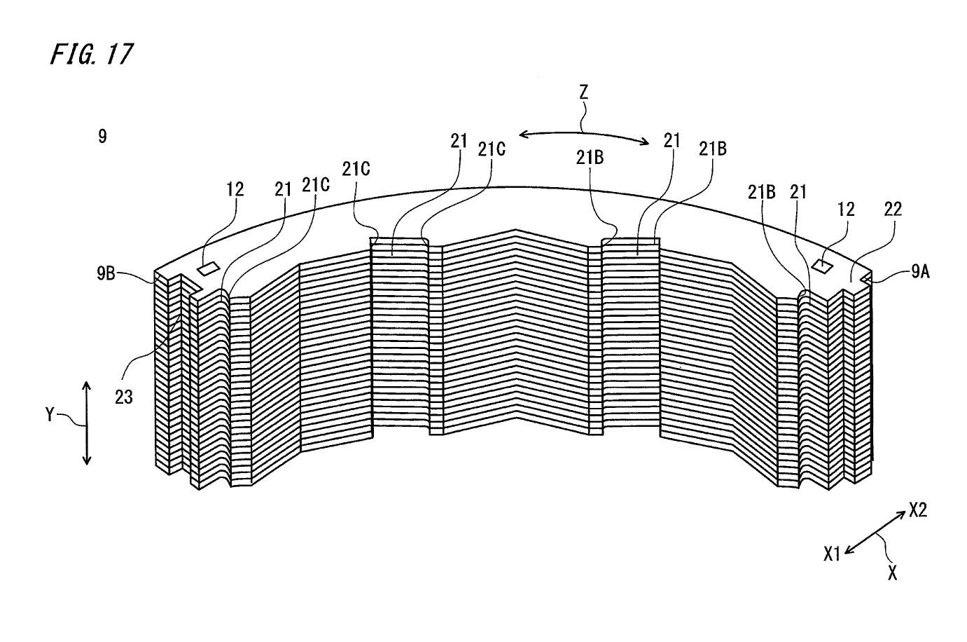

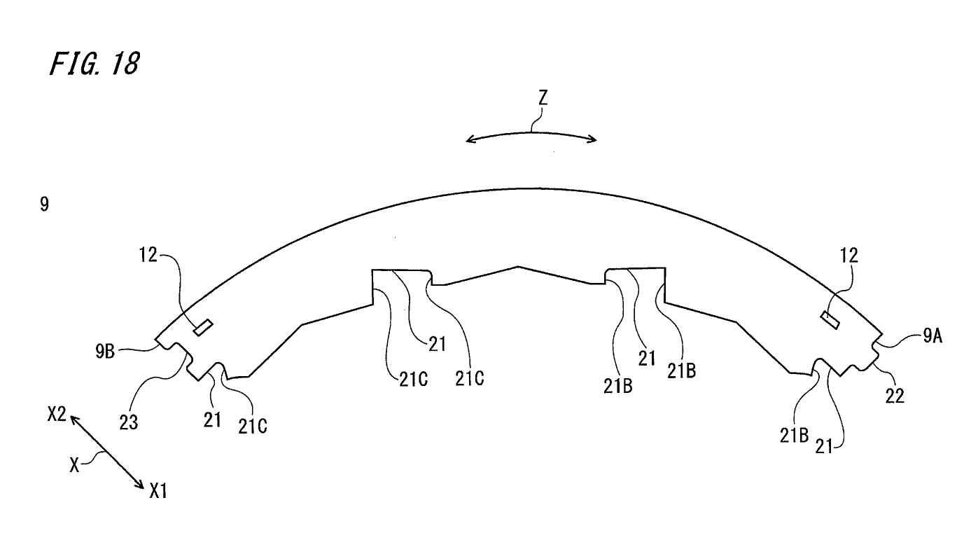

FIG. 13 is a perspective view showing the configuration of a stator for a rotating electric machine according to Embodiment 2 of the present invention. FIG. 14 is a perspective view showing the configuration of a core of the stator shown in FIG. 13. FIG. 15 is a perspective view showing the configuration of an inner core of the core shown in FIG. 14. FIG. 16 is a plan view showing the configuration of the inner core shown in FIG. 15. FIG. 17 is a perspective view showing the configuration of an outer core of the core shown in FIG. 14. FIG. 18 is a plan view showing the configuration of the outer core shown in FIG. 17.

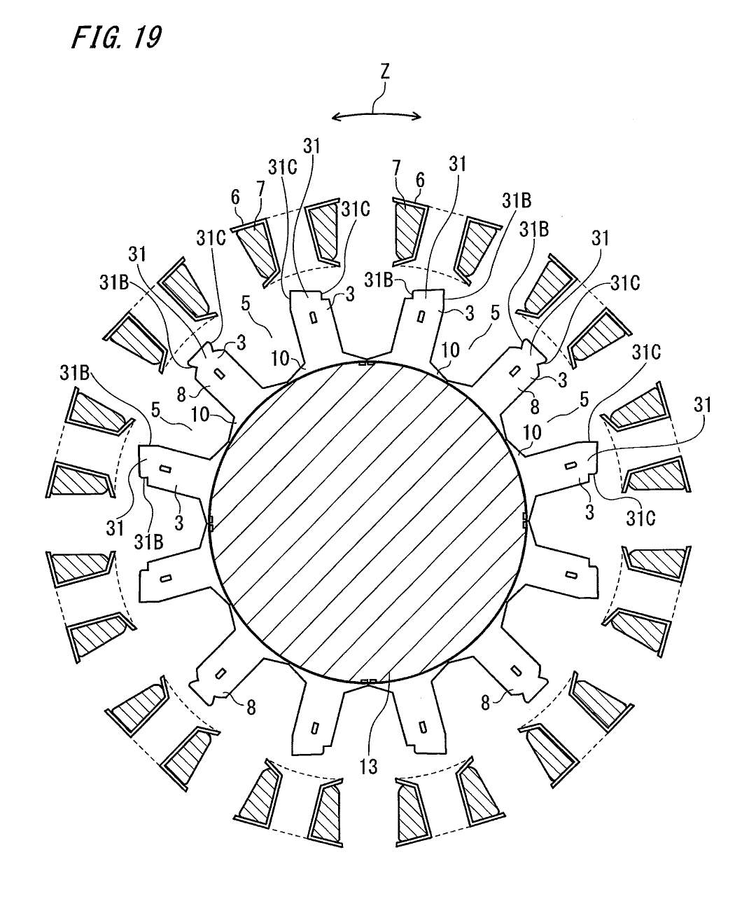

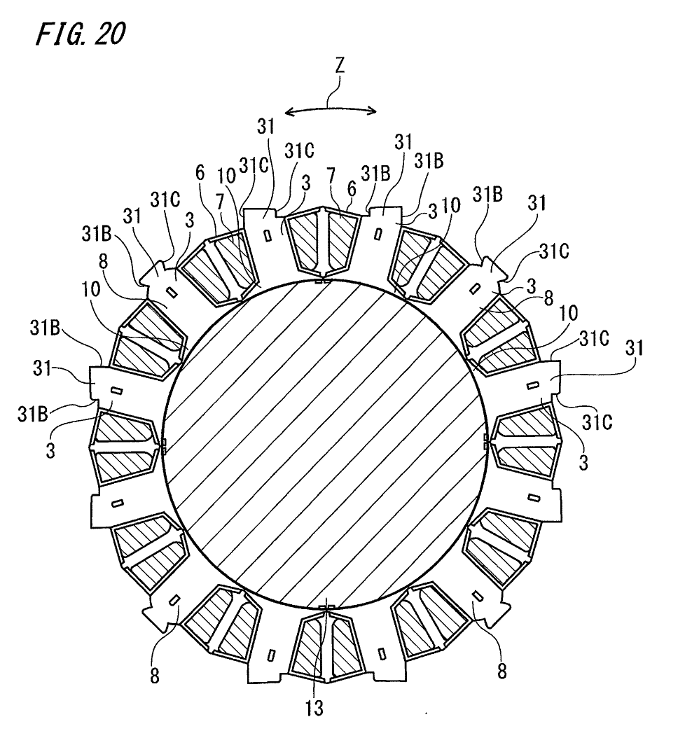

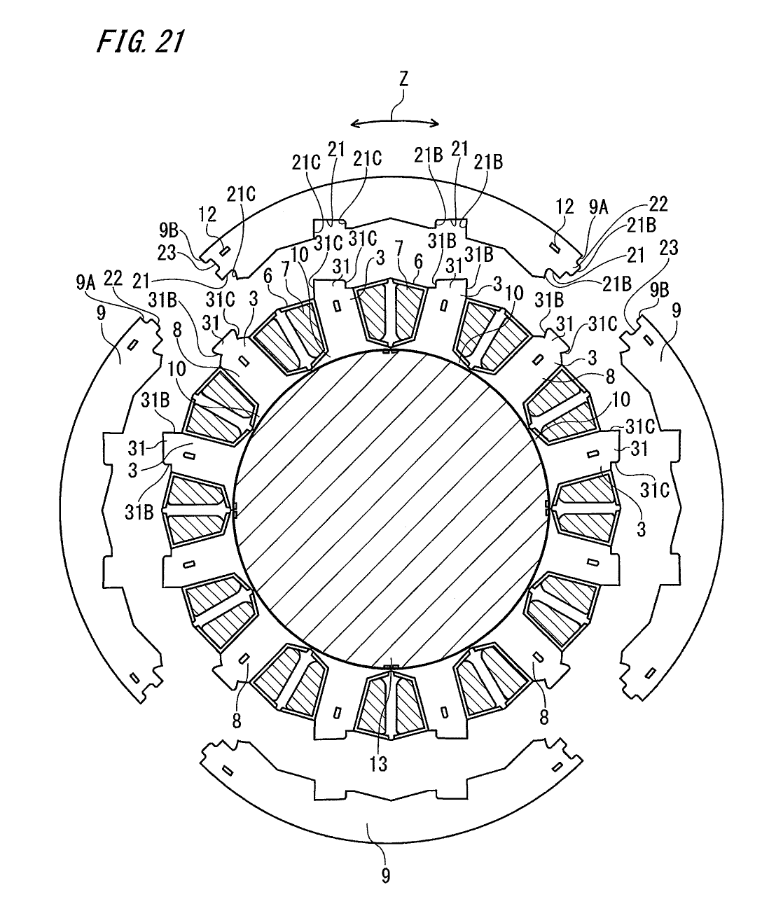

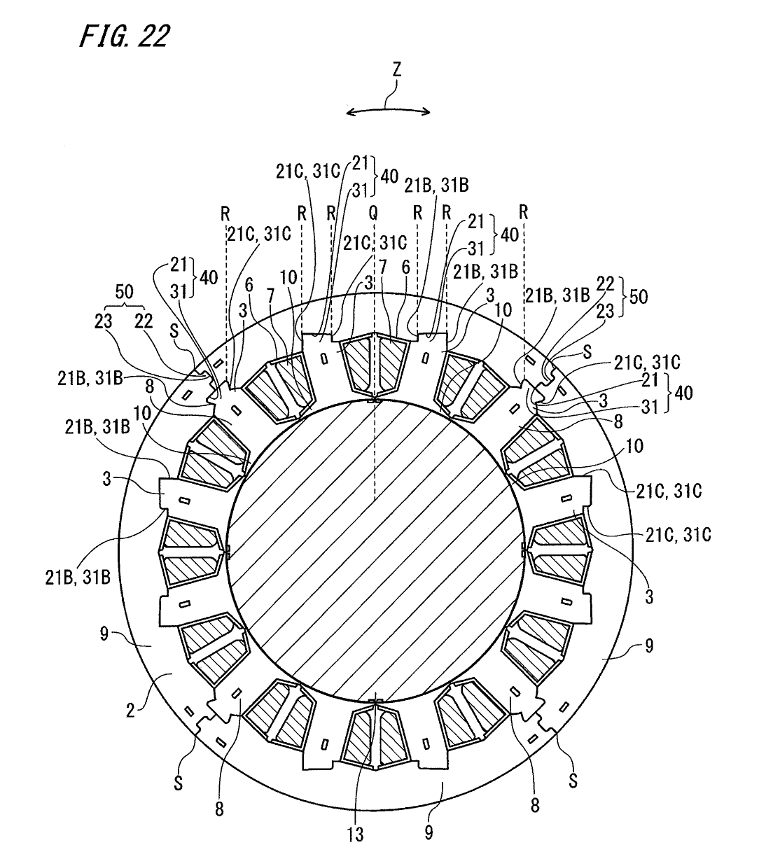

FIGS. 19 to 23 are each a plan view showing a method for manufacturing the stator of the rotating electric machine shown in FIG. 13. FIG. 19 is a plan view showing a state before coils are mounted to the inner core. FIG. 20 is a plan view showing a state after the coils are mounted to the inner core. FIG. 21 is a plan view showing a state before the outer core is mounted to the inner core. FIG. 22 is a plan view showing a state after the outer core is mounted to the inner core.

In FIGS. 15 and 16, similar to Embodiment 1 described above, first projections 31 are formed as first fitting portions 40 of an inner core 8 and at the outer side X2 in the radial direction X with respect to slots 5. Fitting surfaces 31B and fitting surfaces 31C are formed on the first projections 31 in the radial direction X.

In FIGS. 17 and 18, similar to Embodiment 1 described above, first recesses 21 are formed as first fitting portions 40 of an outer core 9 and at the outer side X2 in the radial direction X with respect to the slots 5. Fitting surfaces 21B and fitting surfaces 21C are formed on the first recesses 21 in the radial direction X.

In Embodiment 2, similar to Embodiment 1 described above, the inner core 8 and the outer core 9 are each divided at four locations in the circumferential direction Z, but, unlike Embodiment 1 described above, the division locations S of the outer core 9 are locations at which tooth portions 3 are formed, in the circumferential direction Z, as shown in FIGS. 14 and 22.

In Embodiment 1 described above, the example in which one divided inner core 8 is fitted to one divided outer core 9 at the first fitting portions 40 is shown. However, in Embodiment 2, an example in which two divided inner cores 8 adjacent to each other are fitted to one divided outer core 9 at the first fitting portions 40 such that half portions thereof in the circumferential direction Z extend over the outer core 9 is shown.

The directions in which the fitting surfaces 31B and the fitting surfaces 31C are formed in the inner cores 8 and the fitting surfaces 21B and the fitting surfaces 21C are formed in the outer cores 9, will be described with reference to FIG. 22. Each fitting surface 31B and each fitting surface 31C, and each fitting surface 21B and each fitting surface 21C are formed as surfaces in the axial direction Y at parallel positions R parallel to the radial direction X at the center position Q in the circumferential direction Z of the divided outer core 9. The radial direction X at the center position Q in the circumferential direction Z of the divided outer core 9 is a direction that coincides with an insertion direction in which the divided outer core 9 is inserted from the outer side X2 to the inner side X1 in the radial direction X.

It is noted that the fitting surfaces 31B and the fitting surfaces 31C formed on the inner cores 8 are on the two inner cores 8 adjacent to each other in the circumferential direction Z corresponding to one outer core 9 as shown in FIG. 22, and therefore refer to the fitting surfaces 31B and the fitting surfaces 31C formed on the two inner cores 8.

At the locations of the end portions 9A and 9B in the circumferential direction Z of the outer cores 9, second projections 22 and second recesses 23 are formed as second fitting portions 50 and first recesses 21 are formed as the first fitting portions 40. The first recesses 21 formed at the end portions 9A and 9B in the circumferential direction Z of the outer cores 9 as described above are fitted in a corresponding manner to the first projections 31 formed on the central tooth portions 3 of the inner cores 8 shown in FIGS. 15 and 16.

The first recesses 21 and the first projections 31 formed at the end portions 9A and 9B in the circumferential direction Z of each outer core 9 are formed at positions most distant in the circumferential direction Z from the center position Q in the circumferential direction Z of the divided outer core 9 as shown in FIG. 22. Thus, the degree of tilt of the parallel position R to the center position Q relative to the radial direction X is increased. Therefore, tapered shapes of the fitting surfaces 21B, 21C, 31B, and 31C of the first projections 31 and the first recesses 21 of the first fitting portions 40 formed at the end portions 9A and 9B in the circumferential direction Z of the outer core 9 are formed in a shape having an acute angle as compared to the case of Embodiment 1 described above, so that the first fitting portions 40 at these locations are formed with a structure by which the first fitting portions 40 are less likely to be pulled out.

Next, a method for manufacturing the stator for a rotating electric machine of Embodiment 2 configured as described above will be described with reference to FIGS. 19 to 22. First, similar to Embodiment 1 described above, as shown in FIG. 19, the four inner cores 8 are disposed on the outer periphery of a columnar core metal 13, the respective tooth portions 3 are radially formed, and the slots 5 between the adjacent tooth portions 3 are opened at the outer side X2 in the radial direction X.

Next, the coils 7 wound on the bobbins 6 are inserted to the radially arranged tooth portions 3 from the outer side X2 to the inner side X1 in the radial direction X. Accordingly, each bobbin 6 is disposed in the adjacent slots 5 as shown in FIG. 20. Thus, the coils 7 are disposed in the respective slots 5. At this time, the first projections 31 project to the outer side X2 in the radial direction X with respect to the regions of the slots 5 where the coils 7 are disposed.

Next, after the coils 7 are inserted, the four outer cores 9 are inserted from the outer side X2 to the inner side X1 in the radial direction X as shown in FIGS. 21 and 22. At this time, one outer core 9 is inserted so as to be disposed over the two inner cores 8 adjacent to each other in the circumferential direction Z. Then, the first projections 31 of the adjacent inner cores 8 and the first recesses 21 of the outer core 9 are fitted to each other to form the first fitting portions 40. The insertion direction in which each outer core 9 is inserted at this time coincides with the radial direction X at the center position Q in the circumferential direction Z of the divided outer core 9.

Since each of the fitting surfaces 31B and the fitting surfaces 31C of the first projections 31 of the adjacent inner cores 8 and the fitting surfaces 21B and the fitting surfaces 21C of the first recesses 21 of the outer core 9 is formed as a surface in the axial direction Y at the parallel position R with respect to the center position Q in the circumferential direction Z of the outer core 9, that is, the insertion direction, it is easy to insert the outer cores 9 to the inner cores 8.

Furthermore, the first fitting portions 40 formed at the end portions 9A and 9B in the circumferential direction Z of each outer core 9 are more firmly fitted since the tapered shapes of the fitting surfaces 31B, 31C, 21B, and 21C of the first projections 31 and the first recesses 21 are formed in a shape having an acute angle.

Furthermore, similar to Embodiment 1 described above, the first fitting portions 40 composed of the first projections 31 and the first recesses 21 are formed at the outer side X2 in the radial direction X with respect to the slots 5. Thus, when the first projections 31 and the first recesses 21 are fitted to each other, stress can be prevented from being applied to the coils 7 disposed within the slots 5.

Furthermore, at the end portions 9A and 9B in the circumferential direction Z of the respective outer cores 9, the second projections 22 and the second recesses 23 are fitted to each other, whereby the second fitting portions 50 are formed. When each outer core 9 is inserted from the outer side X2 to the inner side X1 in the radial direction X, the second projections 22 are fitted into the second recesses 23 so as to be squeezed thereinto. The subsequent procedure is the same as in Embodiment 1 described above, and thus the description thereof is omitted as appropriate.

According to the stator for a rotating electric machine, the rotating electric machine, and the method for manufacturing the stator for a rotating electric machine of Embodiment 2 configured as described above, as a matter of course, the same advantageous effects as those in Embodiment 1 described above are achieved. In addition, since the first fitting portions are formed at the end portions in the circumferential direction of the outer cores, the inner cores and the outer cores are more firmly fitted to each other.

### Embodiment 3

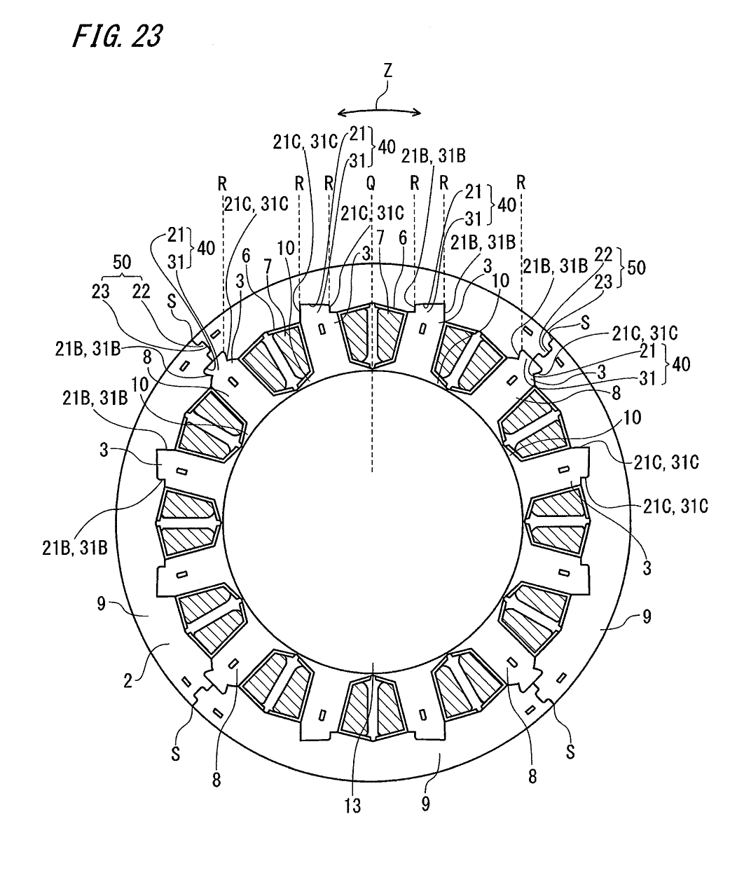

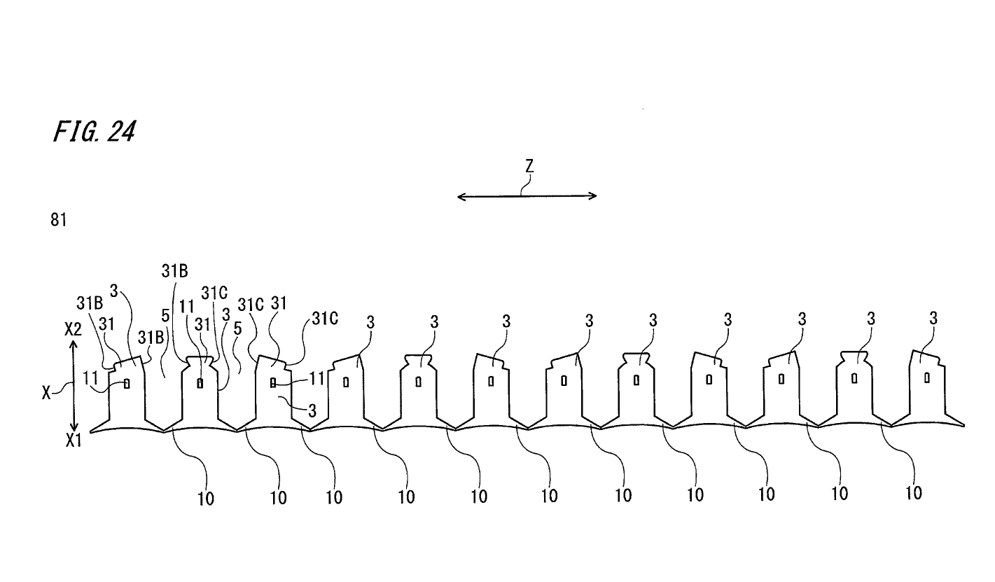

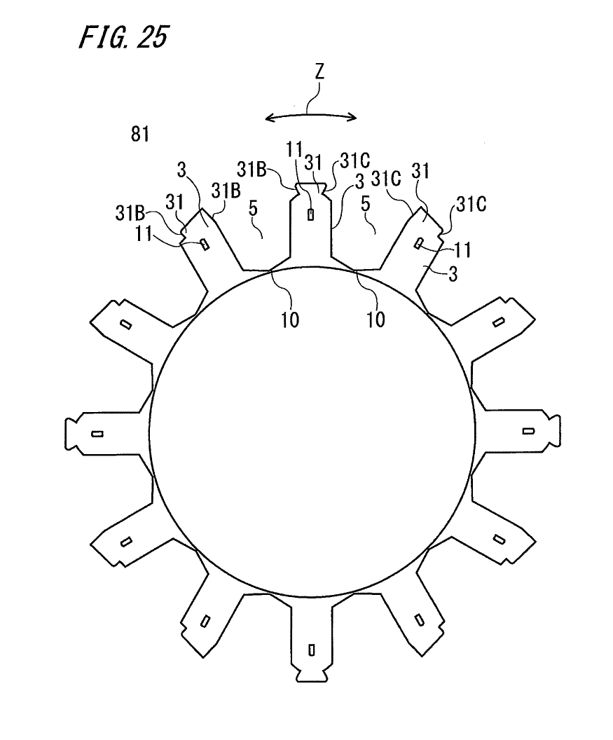

FIG. 23 is a plan view showing the configuration of a stator for a rotating electric machine according to Embodiment 2 of the present invention. FIGS. 24 and 25 are each a plan view showing a method for manufacturing an inner core of the stator shown in FIG. 23. FIG. 24 is a plan view showing a state where the inner core is stamped from a plate material. FIG. 25 is a plan view showing a state where the inner core shown in FIG. 24 is rolled into an annular shape.

In the drawings, the same parts as in each embodiment described above are designated by the same reference characters, and the description thereof is omitted. In Embodiment 3, an inner core 81 is formed in a linear shape as shown in FIG. 24 by stamping a plate material. Thus, as shown in the drawing, in the inner core 81, all tooth portions 3 other than tooth portions 3 at both ends are connected to each other by connection portions 10. As shown in FIG. 25, the linear inner core 81 is formed into an annular shape by being rolled while the connection portions 10 are being plastically deformed. Subsequently, similar to each embodiment described above, the stator for a rotating electric machine is manufactured.

According to the method for manufacturing the stator for a rotating electric machine of Embodiment 3 configured as described above, as a matter of course, the same advantageous effects as those in each embodiment described above are achieved. In addition, since the inner core is formed of one member, the number of components can be reduced, and the productivity can be improved. Moreover, since the inner core is formed in a linear shape, the yield is enhanced as compared to the case with an arc shape.

It is noted that, within the scope of the present invention, the above embodiments may be freely combined with each other, or each of the above embodiments may be modified or simplified as appropriate.

1. A stator for a rotating electric machine, comprising:
a core having
a yoke portion formed in an annular shape,
a plurality of tooth portions formed at an inner peripheral side of the yoke portion so as to be spaced apart from each other at intervals in a circumferential direction and project to an inner side in a radial direction with respect to the yoke portion, and
connection portions connecting the adjacent tooth portions at the inner side in the radial direction; and
coils disposed in slots between the respective tooth portions, wherein
the core is formed of an outer core forming the yoke portion and an inner core forming the tooth portions and the connection portions,
the outer core is formed so as to be divided into a plurality of parts in the circumferential direction,
a plurality of first fitting portions for fitting a plurality of divided outer cores and the plurality of tooth portions to each other are formed in the plurality of divided outer cores and the plurality of tooth portions, and
all fitting surfaces on the outer core and the inner core formed in an axial direction along the radial direction in the plurality of first fitting portions are formed as surfaces parallel to a surface formed in the axial direction along the radial direction at a center position in the circumferential direction of the divided outer core.

2. The stator for a rotating electric machine according to claim 1, wherein the first fitting portion is formed by a first recess of the outer core and a first projection of the inner core.

3. The stator for a rotating electric machine according to claim 1, wherein the divided outer cores are fitted to each other at second fitting portions formed at end portions in the circumferential direction of the outer cores.

4. The stator for a rotating electric machine according to claim 1, wherein division locations of the outer core are locations at which the slots are formed, in the circumferential direction.

5. The stator for a rotating electric machine according to claim 1, wherein
division locations of the outer core are locations at which the tooth portions are formed, in the circumferential direction, and
the first fitting portion is formed at each of end portions in the circumferential direction of the outer core.

6. The stator for a rotating electric machine according to claim 1, wherein the coils are formed so as to be wound on bobbins that are fitted to the tooth portions and disposed in both slots adjacent to the tooth portions.

7. A rotating electric machine comprising:
the stator according to claim 1; and
a rotor disposed so as to be concentric with the stator.

8. A method for manufacturing the stator for a rotating electric machine according to claim 1, the method comprising:
a first step of disposing the coils in the respective slots of the inner core; and
a second step of inserting the divided outer cores from an outer side in the radial direction of the inner core and moving the inner core and the outer core parallel to the fitting surfaces relative to each other to fit the inner core and the outer core at the first fitting portions.

9. The method for manufacturing the stator for a rotating electric machine according to claim 8, further comprising a step of forming the inner core by stamping a plate material into a linear shape, and rolling and mounting the linear inner core in an annular shape, prior to the first step.

10. The stator for a rotating electric machine according to claim 2, wherein the divided outer cores are fitted to each other at second fitting portions formed at end portions in the circumferential direction of the outer cores.

11. The stator for a rotating electric machine according to claim 2, wherein division locations of the outer core are locations at which the slots are formed, in the circumferential direction.

12. The stator for a rotating electric machine according to claim 3, wherein division locations of the outer core are locations at which the slots are formed, in the circumferential direction.

13. The stator for a rotating electric machine according to claim 2, wherein
division locations of the outer core are locations at which the tooth portions are formed, in the circumferential direction, and
the first fitting portion is formed at each of end portions in the circumferential direction of the outer core.

14. The stator for a rotating electric machine according to claim 3, wherein
division locations of the outer core are locations at which the tooth portions are formed, in the circumferential direction, and
the first fitting portion is formed at each of end portions in the circumferential direction of the outer core.

15. The stator for a rotating electric machine according to claim 2, wherein the coils are formed so as to be wound on bobbins that are fitted to the tooth portions and disposed in both slots adjacent to the tooth portions.

16. The stator for a rotating electric machine according to claim 3, wherein the coils are formed so as to be wound on bobbins that are fitted to the tooth portions and disposed in both slots adjacent to the tooth portions.

17. The stator for a rotating electric machine according to claim 4, wherein the coils are formed so as to be wound on bobbins that are fitted to the tooth portions and disposed in both slots adjacent to the tooth portions.

18. The stator for a rotating electric machine according to claim 5, wherein the coils are formed so as to be wound on bobbins that are fitted to the tooth portions and disposed in both slots adjacent to the tooth portions.

19. A rotating electric machine comprising:
the stator according to claim 2; and
a rotor disposed so as to be concentric with the stator.

20. A rotating electric machine comprising:
the stator according to claim 3; and
a rotor disposed so as to be concentric with the stator.
